(19) United States
(12) Patent Application Publication
(10) Pub. No.: US 2003/0005887 A1
(43) Pub. Date: Jan. 9, 2003

(54) Animal feeder

(76) Inventor: Michael W. Graham, Del Rio, TX (US)

Correspondence Address: LAW OFFICES OF CHRISTOPHER L. MAKAY, 1634 Milam Building, 115 East Travis Street, San Antonio, TX, 78205, US

(21) Appl. No.: 09/738,448

(22) Filed: Dec. 15, 2000

(51) Int. Cl. A01K 61/02

(52) U.S. Cl. 119/52.1

(57) ABSTRACT

An animal feeder includes a support structure and a container attached to the support structure. The container includes an inlet that receives feed and an outlet that delivers feed therefrom. The animal feeder further includes a feed station and a cover that seals the inlet of the container. The feed station includes a chute having an inlet attached to the outlet of the container and an outlet that delivers feed received from the container therefrom and a plurality of troughs attached at the outlet of the chute. The animal feeder still further includes a mount attached to the container and to the cover, wherein the mount permits the cover to move from a substantially horizontal closed position sealing the inlet of the container and pivot to a substantially vertical open position exposing the inlet of the container.

### BACKGROUND OF THE INVENTION

1. Field of the Invention

The present invention relates to animal feeders and, more particularly, but not by way of limitation, to an improved animal feeder designed to establish enhanced feeding patterns for targeted species.

2. Description of the Related Art

Game animals in the wild are often attracted through feeding for the purposes of viewing, photographing, or hunting. In attracting game animals, it is essential to understand their habits so that a feeding pattern providing a high probability of encountering a targeted game animal may be established. An important game animal habit includes their formation of small, unassociated groups that travel within a given area. These groups do not interact and, if one group encounters another, the groups quickly separate and often avoid the encounter area in the future. Consequently, establishing a feeding pattern that provides a high probability of encountering a targeted game animal requires the distribution of sufficient feed on a consistent basis at a location for the many groups within an area. Furthermore, the feed must be accessible at the same time to all the game animals within any group so as to avoid an encounter with another group drawn by the feed to the same location.

Feeding game animals in an attempt to establish a known feeding pattern is often accomplished through the placing of bulk amounts of feed on the ground consistently in the same location. Unfortunately, manually feeding game animals through the placing of bulk amounts of feed on the ground suffers many disadvantages. It is a time consuming and labor intensive process that requires a constant intrusion into the game animals' habitat. Further, many non-targeted species, such as raccoons, opossums, porcupines, and the like, eat the feed, which leaves insufficient feed for the establishment of a feeding pattern for targeted game animals.

Various game feeders have been developed to eliminate the manual placement of bulk amounts of feed on the ground. Such game feeders typically consist of a storage container having a solenoid-operated door attached to a timing circuit. A distribution device, which normally is a motor-driven spinner plate, resides under the solenoid-operated door. In operation, the solenoid, responsive to the timing circuit, opens the door after the expiration of a desired time period to deliver feed onto the distribution device, which scatters the feed on the ground about the feeder.

Although these feeders are less time consuming and labor intensive in accomplishing feed distribution than a manual process, they also suffer certain disadvantages. Feeders of the above type normally do not distribute sufficient feed throughout a day to supply the various game animal groups within a given area. Consequently, very few groups or only one game animal group establishes a feeding pattern, which significantly diminishes the probability of encountering a targeted game animal. Furthermore, the containers of the above feeders are typically easily broken into by non-targeted species, such as raccoons, opossums, porcupines, and the like. A non-targeted species accesses the feeder and dumps the feed within the container onto the ground. This permits non-targeted species to consume all the feed, thereby preventing the establishment of a feeding pattern for targeted game animals, resulting in a low probability of encountering such a targeted game animal.

Accordingly, an animal feeder that provides feed for multiple groups of game animals as well as the multiple animals in a group while preventing non-targeted species from eating all the feed contained therein improves over the aforementioned game feeders and feeding techniques.

### SUMMARY OF THE INVENTION

In accordance with the present invention, an animal feeder includes a support structure and a container attached to the support structure. The support structure includes a base, a frame, and a plurality of legs securing the frame above the base. The container includes sidewalls defining an inlet that receives feed and an outlet that delivers feed therefrom, wherein the sidewalls taper downward to provide a funnel shape for gravity delivering feed within the container.

The animal feeder includes a cover that seals the inlet of the container and a feed station. The cover includes a frame, a roof attached to the frame, and a shroud attached to the frame. The feed station includes a chute having an inlet attached to the outlet of the container and an outlet that delivers feed received from the container therefrom and a plurality of troughs attached at the outlet of the chute. A second feed station identical to the first may also be included.

The animal feeder still further includes a mount attached to the container and to the cover, wherein the mount permits the cover to move from a substantially horizontal closed position sealing the inlet of the container and pivot to a substantially vertical open position exposing the inlet of the container. The mount includes a bracket having an aperture therethrough attached to the support structure and a slide having a straight end and an angled end attached to the cover, wherein the slide is adapted to move through the aperture of the bracket. Moving the slide through the bracket from the straight end to the angled end permits pivoting of the cover such that the angled end of the slide resides on the bracket, thereby maintaining the cover in an open position. Moving the slide through the bracket from the angled end to the straight end places the cover in a closed position over the inlet of the container, thereby sealing the container.

It is therefore an object of the present invention to provide an animal feeder that allows multiple animals from a group to feed simultaneously, which facilitates the establishment of a feeding pattern based upon natural game animal feeding habits.

It is another object of the present invention to provide an animal feeder that diminishes the possibility of another animal group encountering the feeding group through the simultaneous feeding of multiple animals in a group.

It is still another object of the present invention to provide an animal feeder that constant gravity supplies feed to feeding stations, thereby furnishing sufficient feed for all animal groups within the area of the animal feeder.

It is even another object of the present invention to provide an animal feeder that provides feed for the purpose of enhancing animal nutrition levels.

It is a further object of the present invention to provide an animal feeder that seals against non-targeted species, such as raccoons, opossums, porcupines, and the like.

It is still a further object of the present invention to provide an animal feeder that prevents moisture from wicking into its feed container.

It is an even further object of the present invention to provide an animal feeder that includes a cover that will not accidentally shut on a feeder user from its open position.

Still other objects, features, and advantages of the present invention will become evident to those of ordinary skill in the art in light of the following.

### BRIEF DESCRIPTION OF THE DRAWINGS

FIG. 1 is a perspective view illustrating an animal feeder according to the preferred embodiment with a cover in a closed position.

FIG. 2 is a perspective view illustrating the animal feeder according to the preferred embodiment with the cover in an open position.

FIG. 3 is a cross-sectional view of the animal feeder according to the preferred embodiment illustrating the attachment of the cover.

### DETAILED DESCRIPTION OF THE PREFERRED EMBODIMENT

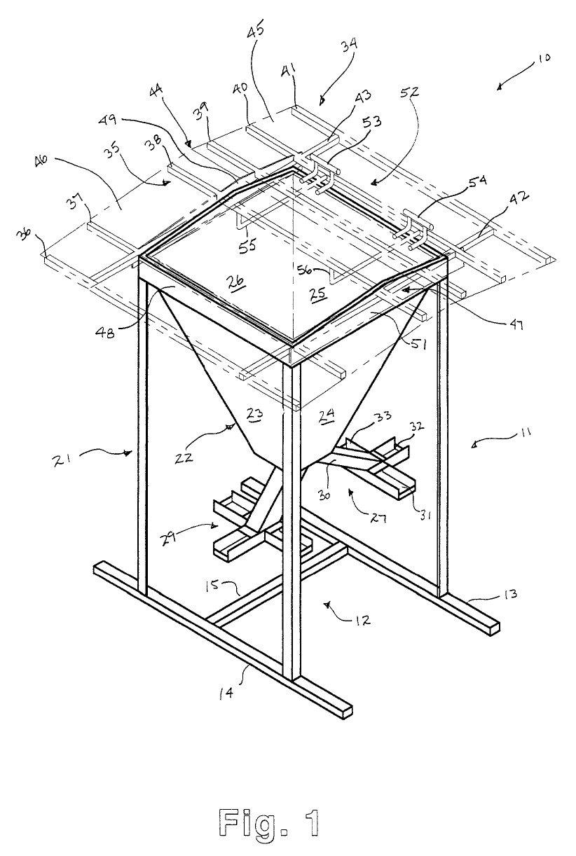

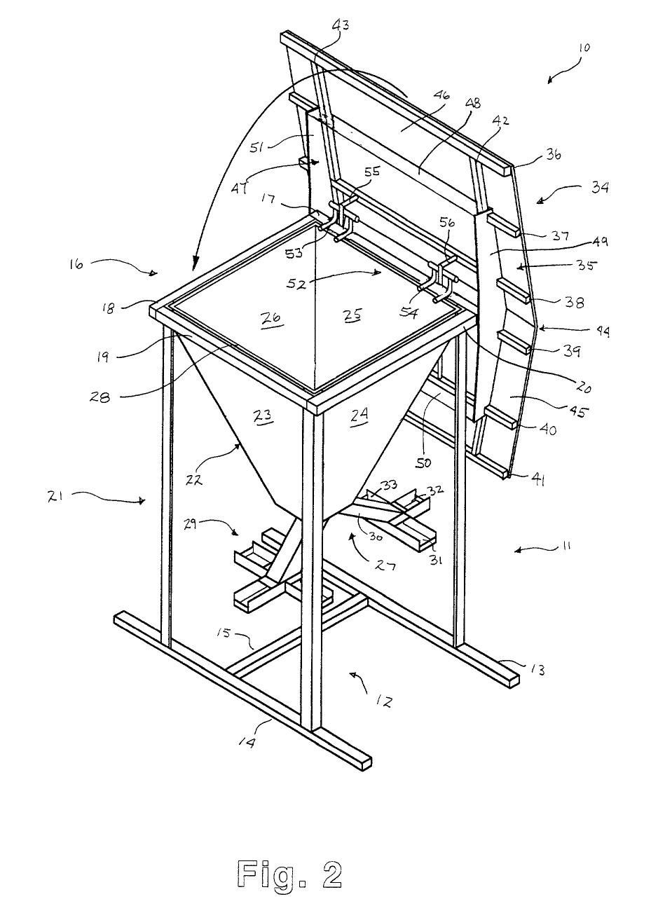

As illustrated in FIGS. 1 and 2, a feeder 10 for game animals, such as deer and the like, includes a support structure 11. The support structure 11 includes a base 12 having feet 13 and 14 and cross-member 15. The cross-member 14 attaches to the feet 13 using any suitable means, such as welding, in order to provide a stable foundation for the feeder 10.

The support structure 11 includes a frame 16 comprised of members 17-20 attached together using any suitable means such as welding. Four legs 21 each attach at one end to the base 12 and at opposite ends to a respective corner of the frame 16, thereby supporting the frame 16 on the base 12 and forming the support structure 11. The four legs 21 attach to the base 12 and to the frame 16 using any suitable means such as welding.

The feeder 10 includes a container 22 for the storing of feed. The container 22 includes a lip 28 thereabout that provides a surface for securing the container 22 within the frame 16. Illustratively, the lip 28 resides on the frame 16 and is attached thereto using any suitable means such as welding to suspend the container 22 within the support structure 11 above the base 12. In this preferred embodiment, the container 22 includes sidewalls 23-26 that taper downward to provide a funnel shape for gravity feeding the feed within the container 22. The container 22 includes an inlet at its upper end for receiving feed into the container 22 and an outlet at its lower end for channeling feed into feeding stations 27 and 29. It should be understood by those of ordinary skill in the art that the sidewalls 23-26 may be attached via direct welding or welded together via a bracket or, alternatively, formed from a single piece bent appropriately to provide the desired shape of the container 22.

The feeder 10 includes the feeding stations 27 and 29 to deliver the feed contained in the container 22 to animals. The feeding station 27 is identical to the feeding station 29; consequently, only the feeding station 27 will be described herein. The feeding station 27 includes a chute 30 and troughs 31-33. In this preferred embodiment, the chute 30 is an enclosed structure having an inlet and an outlet. The inlet portion of the chute 30 attaches at the underside of the container 22 over a portion of the outlet therefrom to receive feed by gravity from the container 22 and deliver the feed from its outlet into the troughs 31-33. The chute 30 attaches to the container 22 using any suitable means such as welding. The outlet of the chute 30 terminates in flanges that facilitate connection of the chute 30 to each of the troughs 31-33. It should be understood by those of ordinary skill in the art that the chute of the feeding station 29 attaches over the remaining portion of the outlet from the container 22 thereby completely covering the outlet from the container 22.

Each of the troughs 31-33 includes a bottom and sidewalls that define a structure for holding feed. The troughs 31-33 attach at the outlet of the chute 30 via the flanges using any suitable means such as welding to receive feed therefrom. In this preferred embodiment 31, the troughs 31 and 33 are formed from one integral piece and trough 32 is attached thereto, however, those of ordinary skill in the art will recognize that the troughs 31-33 could be formed individually.

In operation, feed flows by gravity from the outlet of the container 22 through the chute 30 and into the troughs 31-33. The feed remains in the troughs 31-33 until encountered by a game animal group, which feed from the troughs 31-33. As the feed depletes from the troughs 31-33, additional feed is delivered by gravity from the container 22 via the chute 30 so that the troughs 31-33 remain constantly full. The feeding station 29 operates identically to provide the feeder 10 with six troughs, thus allowing six animals to feed at the same time. Although this preferred embodiment discloses two feeding stations 27 and 29 providing a total of six troughs, those of ordinary skill in the art will recognize that only a single chute and trough are actually required and that any number of feeding stations having any number of troughs may be constructed depending upon the size of the feeder 10 and the number of game animals requiring feeding at any one time.

The use of multiple troughs 31-33 as well as the troughs of the feeding station 29 improves game animal feeding because it allows multiple animals from a group to feed simultaneously, which facilitates the establishment of a feeding pattern based upon natural game animal feeding habits. The simultaneous feeding of multiple animals in a group also permits quick feeding of the entire group, which diminishes the possibility of another animal group encountering the feeding group. In addition, the constant gravity supply of feed to the feeding stations 27 and 29 furnishes sufficient feed for all animal groups within the area of the feeder 10, which significantly enhances the probability of encountering a targeted game animal.

The feeding stations 27 and 29 provide a still further improvement in that non-targeted species, such as raccoons, opossums, porcupines, and the like, cannot enter the feeder 10 through the feeding stations 27 and 29 as the chute apertures are far too small. Even further, feeding stations 27 and 29 due to their chutes prevent feed spillage and also moisture from wicking into the container 22 and ruining the feed therein, which allows for a large container 22 that does not require frequent filling.

As illustrated in FIGS. 1-3, the feeder 10 includes a cover 34 movable from an open position that permits the filling of the container 22 with feed to a closed position that seals the container 22 to prevent contaminants, such as rain and dirt, from contacting the feed therein. The cover 34 further seals the container 22 to prevent non-targeted species from accessing the container 22 and eating all the feed contained therein. The cover 34 includes a frame 35 comprised of joists 36-41 and cross-members 42 and 43. The joists 36-41 connect to the cross-members 42 and 43 using any suitable means, such as welding, to provide a sub-structure for the cover 34. The cover 34 further includes a roof 44 comprised of roof sections 45 and 46. The roof sections 45 and 46 attach to the joists 36-41 and the cross-members 42 and 43 using any suitable means such as screws or nuts and bolts. The cover 34 still further includes a shroud 47 comprised of members 48-51. The members 48 and 50 attach to a respective joist 37 and 40 using any suitable means such as screws and nuts and bolts. Similarly, the members 49 and 51 attach to a respective cross-member 42 and 43 using any suitable means such as screws or nuts and bolts. Upon the closing of the cover 34, the shroud 47 encompasses the frame 16 and is adjacent thereto and the roof 44 lays over the container 22 to completely seal the container 22, thereby preventing contaminants, such as rain and dirt, from entering the container 22 and non-targeted species from accessing the container 22 to eat the feed contained therein.

The feeder 10 includes a mount 52 for securing the cover 34 to the support structure 11 and further for facilitating the movement of the cover 34 from a closed position sealing the container 22 to an open position permitting the filling of the container 22 with feed. The mount 52 includes brackets 53 and 54 and slides 55 and 56. The brackets 53 and 54 attach to the member 17 of the frame 16 using any suitable means, such as welding, and include an aperture for receiving a respective slide 55 and 56 therethrough. The slides 55 and 56 attach at respective angled end to the joist 38 and at an opposite straight end to the joist 40 using any suitable means, such as welding. The slides 55 and 56 pass through a respective aperture of the brackets 53 and 54 to secure the cover 34 to the frame 16 and, thus, to the support structure 11.

Movement of the cover 34 from its closed position to its open position requires the lifting of the cover 34 such that the member 48 of the shroud 47 passes over the member 19 of the frame 16. The cover 34 is then slid horizontally from the side of the frame 16 including member 19 to the side of the frame 16 including the member 17. The movement of the slides 55 and 56 through the apertures of the brackets 53 and 54 permits the horizontal sliding of the cover 34. When the slides 55 and 56 have passed through the brackets 53 and 54 from their straight ends to their angled ends, the cover 34 pivots substantially 90° and is held in place due to the angled ends of the slides 55 and 56 residing on the brackets 53 and 54 as illustrated in FIG. 2. In the fully opened position, the inlet into the container 22 is exposed to permit filling of the container 22, and, further, the cover 34 is held in a position where it cannot accidentally close. Thus, the feeder 10 includes a safety feature whereby the cover 34 cannot accidentally slam shut on a feeder user.

Movement of the cover 34 from its open position to its closed position requires lifting the cover 34 upward so that the angled ends of the slides 55 and 56 move off the brackets 53 and 54. The cover 34 is then pivoted from its substantially vertical position to its substantially horizontal position wherein the slides 55 and 56 are positioned to return through the apertures of the respective bracket 53 and 54. Next, the cover 34 is slid horizontally from the side of the frame 16 including member 17 to the side of the frame 16 including the member 19, thereby returning the cover 34 over the container 22. When the member 48 of the shroud 47 passes the member 19 of the frame 16, the cover 34 is released to again seal the container 22. Although the mount 52 in this preferred embodiment includes brackets 53 and 54 and slides 55 and 56, those of ordinary skill in the art will recognize that only a single bracket and single slide are actually required to permit the movement of the cover 34.

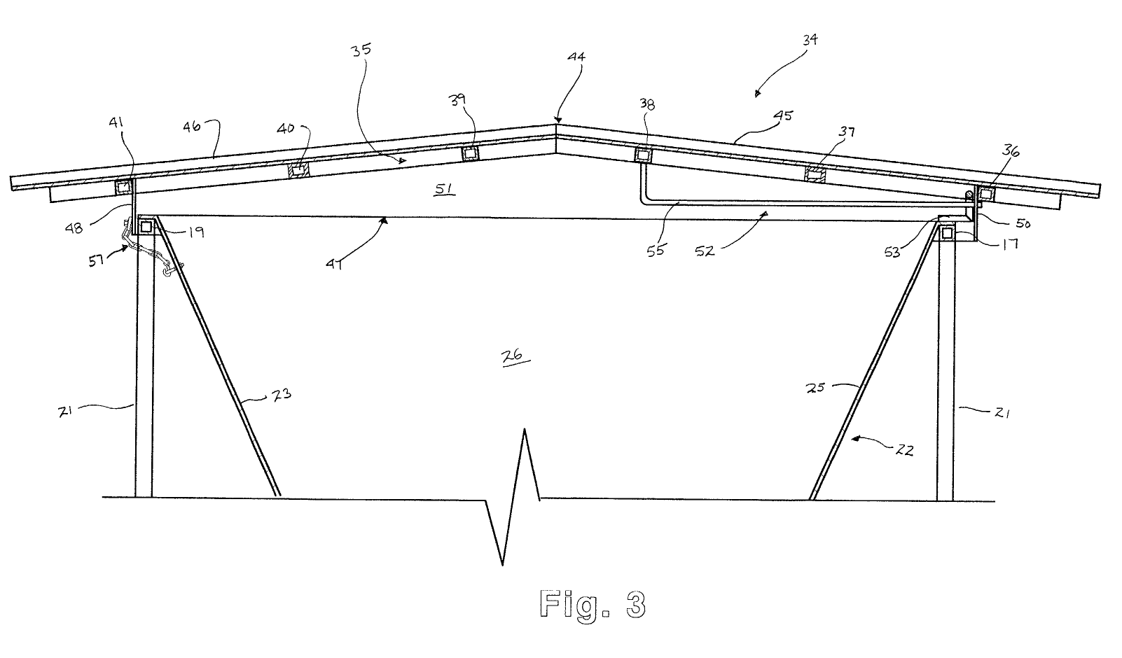

As illustrated in FIG. 3, the feeder 10 includes a lock 57, which, in this preferred embodiment, comprises a chain secured at one end to the member 48 of the shroud 47 via a screw and a hook at the opposite end of the chain for releasable engagement with an eye hook attached to the sidewall 23 of the container 22.

Although the present invention has been described in terms of the foregoing embodiment, such description has been for exemplary purposes only and, as will be apparent to those of ordinarily skill in the art, many alternatives, equivalents, and variations of varying degrees will fall within the scope of the present invention. That scope, accordingly, is not to be limited in any respect by the foregoing description; rather, it is defined only by the claims that follow.

I claim:

1. An animal feeder, comprising:
a support structure;
a container attached to the support structure, the container including an inlet that receives feed and an outlet that delivers feed therefrom; and
a feed station, comprising:
a chute including an inlet attached to the outlet of the container and an outlet that delivers feed received from the container therefrom, and
a plurality of troughs attached at the outlet of the chute.

2. The animal feeder according to claim 1, further comprising a cover that seals the inlet of the container.

3. The animal feeder according to claim 2, further comprising a mount attached to the container and to the cover, wherein the mount permits the cover to move from a substantially horizontal closed position sealing the inlet of the container and pivot to a substantially vertical open position exposing the inlet of the container.

4. The animal feeder according to claim 1, further comprising:
a second feed station, comprising:
a chute including an inlet attached to the outlet of the container and an outlet that delivers feed received from the container therefrom, and
a plurality of troughs attached at the outlet of the chute.

5. The animal feeder according to claim 1, wherein the chute is an enclosed structure providing the inlet and outlet.

6. The animal feeder according to claim 1, the support structure, comprising:
a base;
a frame; and
a plurality of legs securing the frame above the base.

7. The animal feeder according to claim 1, the container, comprising sidewalls including a downward taper that provides a funnel shape for gravity delivering feed within the container.

8. The animal feeder according to claim 2, the cover, comprising:
a frame;
a roof attached to the frame; and
a shroud attached to the frame.

9. The animal feeder according to claim 2, further comprising:
a mount, comprising:
a bracket attached to the support structure, the bracket including an aperture therethrough; and
a slide adapted to move through the aperture of the bracket, the slide including a straight end attached to the cover and an angled end attached to the cover.

10. The animal feeder according to claim 9, wherein moving the slide through the bracket from the straight end to the angled end permits pivoting of the cover such that the angled end of the slide resides on the bracket, thereby maintaining the cover in an open position.

11. The animal feeder according to claim 10, wherein moving the slide through the bracket from the angled end to the straight end places the cover in a closed position over the inlet of the container, thereby sealing the container.

12. An animal feeder, comprising:
a support structure;
a container attached to the support structure, the container including an inlet that receives feed and an outlet that delivers feed therefrom;
a feed station attached to the outlet of the container;
a cover that seals the inlet of the container; and
a mount attached to the container and to the cover, wherein the mount permits the cover to move from a substantially horizontal closed position sealing the inlet of the container and pivot to a substantially vertical open position exposing the inlet of the container.

13. The animal feeder according to claim 12, the feed station, comprising:
a chute including an inlet attached to the outlet of the container and an outlet that delivers feed received from the container therefrom, and
a plurality of troughs attached at the outlet of the chute.

14. The animal feeder according to claim 13, wherein the chute is an enclosed structure providing the inlet and outlet.

15. The animal feeder according to claim 12, the support structure, comprising:
a base;
a frame; and
a plurality of legs securing the frame above the base.

16. The animal feeder according to claim 12, the container, comprising sidewalls including a downward taper that provides a funnel shape for gravity delivering feed within the container.

17. The animal feeder according to claim 12, the cover, comprising:
a frame;
a roof attached to the frame; and
a shroud attached to the frame.

18. The animal feeder according to claim 12, the mount, comprising:
a bracket attached to the support structure, the bracket including an aperture therethrough; and
a slide adapted to move through the aperture of the bracket, the slide including a straight end attached to the cover and an angled end attached to the cover.

19. The animal feeder according to claim 18, wherein moving the slide through the bracket from the straight end to the angled end permits pivoting of the cover such that the angled end of the slide resides on the bracket, thereby maintaining the cover in an open position.

20. The animal feeder according to claim 19, wherein moving the slide through the bracket from the angled end to the straight end places the cover in a closed position over the inlet of the container, thereby sealing the container.
